(19) United States
(12) Patent Application Publication
(10) Pub. No.: US 2003/0074650 A1
(43) Pub. Date: Apr. 17, 2003

(54) Debugger operating system for embedded systems

(76) Inventors: Tankut Akgul, Eskisehir (TR); Pramote Kuacharoen, Trang (TH); Vincent J. Mooney III, Decatur, GA (US); Vijay K. Madisetti, Marietta, GA (US)

Correspondence Address: NORA M. TOCUPS, P.O BOX 698, 140 PINECREST AVE, DECATUR, GA, 30030, US

(21) Appl. No.: 10/273,192

(22) Filed: Oct. 17, 2002

Related U.S. Application Data
(60) Provisional application No. 60/329,861, filed on Oct. 17, 2001.

(51) Int. Cl. G06F 9/44; H02H 3/05

(52) U.S. Cl. 717/129; 717/130; 714/38

(57) ABSTRACT

Configuration of a debugger that saves resources and debugs on a target system rather than from a host system. The target system stores a table with global variables and addresses, and a module table with system-wide functions and addresses. In response to a trigger, a debugger module is loaded from the host system and linked to the target system by causing the debugger module to exchange information with the tables. The debugger module uses the table to find a variable address and sets a pointer to the address. The debugger module provides the table with a local name and address of a variable local to the debugger module. The debugger module uses the module table to find an MT address of a function and sets a pointer to the MT address. The debugger module provides the module table with an MT address of a function local to the debugger module.

### RELATED APPLICATION

This application claims priority to and the benefit of the prior filed co-pending and commonly owned patent application, which has been assigned U.S. patent application Ser. No. 60/329.861, which is entitled “A Dynamically Instantiated Real-Time Operating System Debugger,” filed on Oct. 17, 2001, and which is incorporated herein by this reference.

### FIELD OF THE INVENTION

The inventions relate to the debugging of application programs running on an operating system (OS), and particularly relate to the configuration of debugging systems.

### BACKGROUND

Software debugging methodologies differ according to the hardware platform intended for application development. For general purpose computing, debugging of an application can be done by using sophisticated debugger tools. These tools help the software engineer both to specify the location of the error and to remove the error from the application by providing features such as single stepping, breakpoint setting, and register/memory display. The debugger tool runs on the same hardware platform as the application being debugged and is completely separate from the application, so that the debugger is installed on the system at a different time than the application program (most probably prior to the installation of the application program). Debugging in such a platform makes use of available input/output devices, such as a display terminal and a keyboard, so that the user can easily interact with the software being debugged.

Debugging of embedded applications is typically performed in a different way than debugging is performed for general purpose computing. First of all, the platform on which the software is written, usually a host computer with input/output devices, is usually different than the platform on which the software will eventually be running: the target embedded system. Although the earlier stages of software development can be accomplished on the host computer, the final code development has to be done on the target embedded system in order to be able to capture the errors related to the target platform, such as an error which only occurs during collecting samples from an attached sensor in the embedded system. However, embedded systems are usually limited in terms of observability which can be defined as the information that can be gathered from such systems. This is due to the high-integration level of embedded systems which makes it very hard to directly connect input/output devices to the embedded system internals to send/retrieve information to/from them. For instance, it is very hard to get information about every signal that is occurring within a System-on-a-Chip device which has multiple processors and lots of custom logic inside. This is because the number of external pins of such a device is limited.

A second difference in the way embedded software is debugged comes from a property of embedded software itself. Because of the intended environment for which embedded systems are designed, the applications that run on embedded systems are usually real-time applications that require real-time constraints to be satisfied during their operation. As an example, an embedded system that controls the brake system of an automobile should certainly operate within real-time constraints. Consequently, embedded applications are usually implemented using an operating system and preferably a real-time operating system (RTOS) that provides the coordination between the tasks of the real-time applications running on the embedded system. Therefore, the timeliness of debugging information is as important as the amount of debugging information that can be gathered from an embedded system.

There are different methods followed to debug embedded systems. These methods can be divided into to categories: (1) hardware approaches; and (2) software approaches.

Poret et al. describe a hardware approach in U.S. Pat. No. 4,674,089 entitled “In-circuit emulator.” An in-circuit emulator (ICE) is a hardware unit that contains a support for real-time event detection, real-time tracing, and memory emulation. An ICE consists of an emulator probe, which is physically and functionally equivalent to the target processor that runs the embedded software. The probe, however, consists of a bond-out version of the processor. In a bond-out version of a processor the internal signals are reachable from outside. By using these pins, the internal signals can be captured and interpreted in real-time. The problem with. ICEs, however, is that they lag processor production time and become useless as the latest available processor version changes. Furthermore, ICEs are usually very expensive.

Somasundaram et al. describe an on-chip debugger support in U.S. Pat. No. 5,491,793 entitled “Debug Support in a Processor Chip.” In this method, the whole debugger software runs on a separate host computer and communicates with the target processor that runs the embedded software using some external pins of the processor. The internal debug logic of the processor provides a hardware support for real-time tracing and trapping of instructions being executed on the target processor. In similar implementations with some latest processors (e.g., MIPS32, MPC860 and ARM9), which have on-chip debug support, the communication link between the host computer and the processor is established via a Joint Test Action Group (JTAG) or Background Debug Mode (BDM) interface. These processors support a set of dedicated pins (connected to the internal debugging logic) by which a debugger program running on the host computer can observe some internal signals of these processors and extract debug information from the interpretation of those signals.

Roy et al. describe another hardware approach in U.S. Pat. No. 6,321,331 entitled “Real time debugger interface for embedded systems.” In this approach, two decoders are coupled to the instruction memory, the instruction counter, and the cause register of the sequencer of the processor. A three-bit real time output from the decoders indicating processor activity (e.g., an exception has occurred and a branch is taken) is recorded on a trace buffer that is also implemented in hardware. By combining the three-bit status information with the information about the instructions of the software, execution of the software can be traced in real-time.

As these embedded system debugging methods show, the requirement of retrieval of debugging information in time from an embedded system can be satisfied using some form of hardware assistance in the embedded system. Hardware usage, however, brings extra cost and inflexibility. Also, the amount of information that can be obtained using fixed hardware is also fixed.

Another approach that can be followed is the software approach where the debugging information can be gathered by using debugging agents within the embedded software that is being debugged. These agents are small pieces of code that can either send the necessary information from the embedded platform to the host computer using the communication link in-between, or that can store the debugging information locally to be retrieved afterwards. Since software is used to retrieve the debugging information, there is some effect on the timing of the embedded application. With well-written debugging agents, however, this effect can be kept within acceptable limits.

Rees et al. describe a software debugging approach in U.S. Pat. No. 6,161,200 entitled “Method and apparatus for analyzing software executed in embedded systems.” In this approach, software is instrumented with tag statements that are executed on the target. Tags write information to a predefined address on the processor address space that is monitored by probes attached to the system bus of the processor and provide debugging information such as function and task execution times, memory allocation, call pairs, and program tracing. Once software is instrumented with tags and is compiled, however, the information that the tags can provide becomes fixed until the tags are changed and the code is recompiled and re-executed. The recompilation requirement overshadows the flexibility advantage of software over hardware as recompilation may increase debugging time considerably.

Mulchandani et al. disclose another software approach in U.S. Pat. No. 5,689,684 entitled “Method and apparatus for automatically reconfiguring a host debugger based on a target MCU identity.” In this approach, some amount of flexibility is provided with the help of software implementation where the host debugger can adapt to the target system according to the target processor identity dynamically. Therefore, as opposed to hardware approaches such as using ICEs, the target platform can be debugged independently of the processor type or version. This approach, however, still does not provide any flexibility in terms of debugging functionality that can be modified dynamically.

At least equally important when using a software approach is that there is an extra challenge for debugging embedded software due to scarce resources on the embedded system. It is a luxury to run a debugger agent on an embedded system with application programs and possibly with an operating system (OS). The debugger agent eats up memory on the embedded system leaving less memory space for the application programs and the OS. For example, for a handheld device which runs an application for decoding and playing back compressed movies streamed from a server, considerable amount of memory may be needed for buffering the compressed movie before decompressing and playing it back. It is important to be able to debug such a multi-media application while the application is running on the handheld device without significant consumption of additional memory which is needed for buffering the multimedia data.

One solution to the memory problem is isolating the debugging agent from the applications on the target and placing the debugging agent in a separate memory module just for the software development stage. The embedded system debugging method using a so-called “debug monitor” fits into this category. A debug monitor is a small debugging agent that is burned on read-only memory (ROM) in the target platform. Once a ROM is added to the target platform, however, it is hard to remove the ROM, so the added ROM is usually kept in the final product at an additional cost. Moreover, since the ROM memory reserved for the debug monitor is usually kept small for cost reduction, the debugging functionality that can be obtained by using a debug monitor is limited.

Therefore, it is desirable to find an efficient and flexible mechanism which provides debugging of embedded software without consuming significant additional amounts of memory of the target platform and without requiring any dedicated debugging hardware and yet provides detailed and timely debugging information about the internals of the target platform.

### SUMMARY

The inventions provide a debugging system that saves resources of the system on which it operates. The debugging system is made up of debugging modules that may be dynamically and incrementally loaded and linked to the system to be debugged. When the inventions are used in a computer system including a host system connected to a target system, the inventions save the resources of the target system and yet allow for the debugging operations to be conducted on the target system rather than the host system. An exemplary embodiment of the inventions presents an operating system (OS) based debugging methodology for embedded systems in which the debugger is a dynamically and incrementally loadable set of modules of the operating system. For this reason, the methodology is named as Debugger OS.

Each debugger module is written to provide a specific debugging feature. Each feature can be a non-real-time functionality such as breakpoint or single stepping support that is especially useful in the earlier stages of software development, or can be a real-time functionality such as dynamic variable query or dynamic program tracing without halting application program execution. Dynamically loading a new debugger module adds to the target system a new debugging feature that is provided by the module. Since debugger modules are dynamically loaded, the modules do not consume target embedded system memory resource while not in a debugging session. In other words, debugger modules are loaded into the target system memory and are executed only when they are needed for debugging purposes. Furthermore, the information obtained by the debugger modules can be directly sent from the embedded platform to a host computer via a communication interface. In this way, the need for the memory space on the target platform for the storage of the debugging data can be reduced or eliminated. There is also a flexibility brought by dynamically loadable debugger modules: new debugger modules that provide additional debugging functionality can be designed and integrated to the system at any point in time.

Debugger modules that run on the target system provide detailed state information about target system internals. As the debugger modules run on the target platform rather than on a host computer, it is possible to collect information about the internals of the target system no matter how deeply embedded the target platform is. One example of this detailed system information is the register state of a processor. In a processor without a dedicated monitoring and debugging logic inside, register state cannot be observed via external pins of the processor directly. Therefore, a debugger tool that monitors signals on the external pins of the processor cannot obtain information about the register state of the processor. Since the Debugger OS modules run on the processor itself, these modules can obtain register state information by executing specific instructions of the processor. Then, the register state information can be sent to or monitored from the user interface running on the host computer via the communication interface between the target processor and the host computer.

Another advantage of OS modules comes with the concept of OS-aware debugging. OS-awareness is debugging software code based on an operating system thread or an operating system process, rather than on a procedure in the programming language. OS modules can have complete access to OS internals such as task control blocks (TCBs), the ready task table, semaphores and mailbox structures. Access to these OS internals allows the Debugger OS to have a wider control over the system and, thus, to provide more detailed information in case of a failure condition. Therefore, the Debugger OS modules are able to differentiate between the operating system threads or processes by using the detailed state information about the OS internals. Conventional debuggers fail in multi-threaded environments where there is no way to differentiate between threads. Thus, for instance, a breakpoint set on one thread or a process affects all instances of the thread code.

Incremental debugger module loading provides the user with the ability to load only the debugger modules that are needed for requested debugging features. Any undesired modules can be unloaded anytime during debugging; this further helps provide efficient memory usage in the system.

### BRIEF DESCRIPTION OF THE DRAWINGS

FIG. 1 illustrates an exemplary environment for the inventions of a host system and a target system.

FIG. 2 is a flow chart showing exemplary actions of dynamic module loading and linking.

FIG. 3 illustrates structure of an exemplary debugger module and exemplary memory organization of the target memory in the system model.

FIG. 4 shows an exemplary global variable table and an exemplary module table.

FIG. 5 illustrates exemplary circumstances that may lead to loading of a debugger module.

FIG. 6 illustrates an exemplary embodiment of the invention where an application code is instrumented to catch integer divide-by-zero error and to trigger a dynamic addition of a custom-made debugger module into the system.

FIG. 7 shows an exemplary display on a user interface that runs on a host computer in an exemplary embodiment of the invention with the divide-by-zero error detection.

FIG. 8 illustrates an exemplary display on a user interface of the debugging information that may be provided by an exemplary debugger module in the divide-by-zero error detection example.

FIG. 9 is a schematic illustrating exemplary structure of on-chip hardware support for breakpoints.

FIG. 10 illustrates exemplary functionality of a debugger module as used in an embodiment of the invention for OS-aware breakpoint support.

### DETAILED DESCRIPTION

Several embodiments of the inventions are described below in detail. The disclosed embodiments are intended to be illustrative only since numerous modifications and variations therein will be apparent to those of ordinary skill in the art. In reference to the drawings, like numbers will indicate like parts continuously throughout the views. As utilized in the description herein and throughout the claims that follow, the meaning of “a,” “an,” and “the” include plural references also, unless the context of use clearly dictates otherwise. Additionally, the meaning of “in” includes “in” and “on” unless the context clearly dictates otherwise as the term is utilized in the description herein and throughout the claims that follow.

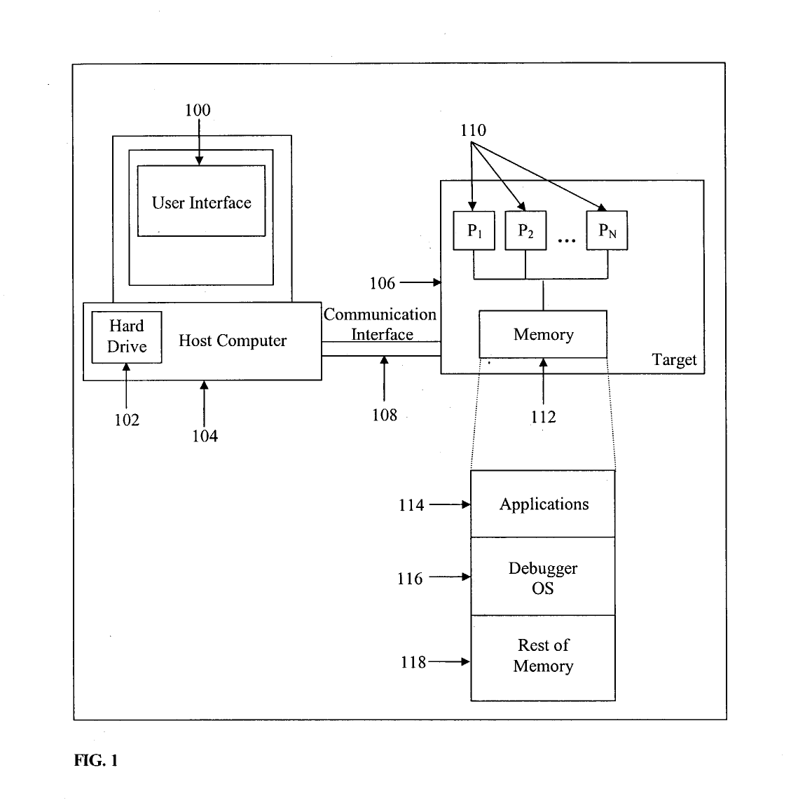

An exemplary debugging platform for Debugger OS applications is shown in FIG. 1. The Debugger OS 116 (such as one or more debugger modules of a debugger system) and the application(s) 114 reside in the memory 112 installed on the target system 106. Advantageously, the debugger software of the debugger modules is completely inside the OS code and runs on the target processor(s) 110.

The host computer 104, on the other hand, runs the user interface 100. The communication between the host system and the target system may be established by any suitable wired or wireless communication interface 108. This interface is preferably chosen so as to provide high bandwidth data transfer capability if real-time debugging is desired. For the least amount of disturbance on the real-time behavior of the running applications on the target, the communication interface can be established by probing the address and data busses of the target processor and reading the signals on these busses to obtain the necessary information from the target as long as these busses are reachable for probing. If no such interface is available, then a small temporary buffer can be reserved in the memory 112 at the target platform for storing the debugging data and a task can be assigned in the OS to send the stored data to the host computer periodically or whenever the load of the system decreases. The size of the buffer can be adjusted according to the communication bandwidth so that it is almost fully utilized without overflow. To do this, the buffer fill level can be fed back to the OS to adjust the scheduling parameters for the task that is sending debugging information to the host computer. By leaving the control of debugging information transfer to the OS, the disturbance on the real-time operation of the application(s) running on the target platform is minimized with minimal memory consumption.

In the exemplary embodiment, software debugging features are distributed between and among distinct debugger modules that are compiled independently from each other. The user can select the necessary modules corresponding to the desired debugging features at compile time. In addition to compile time selection, each module is a dynamically loadable and linkable part of the OS. Advantageously, when a debugger module is needed at runtime for extra debugging features, that module can be added to the system without the requirement of application or OS recompilation or a reboot.

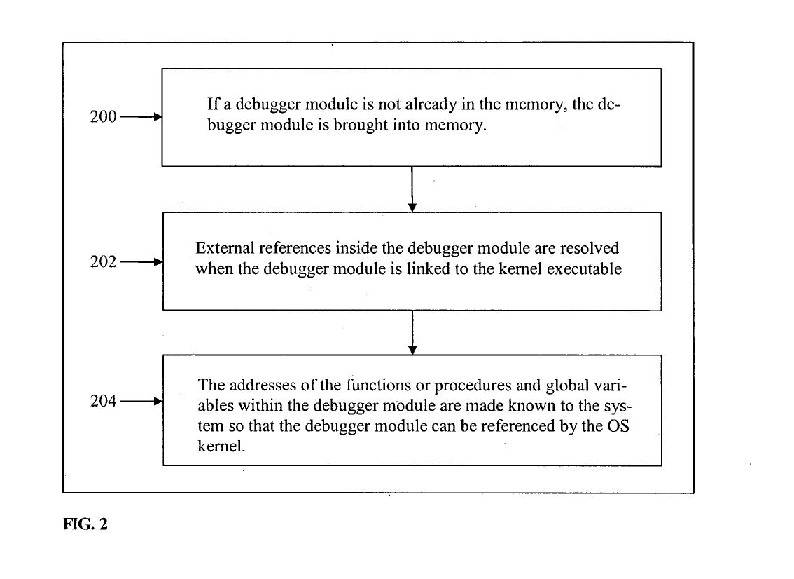

The loading and the linking processes of the debugger modules at run-time are handled by application programming interface (API) functions. API functions take as a parameter the module name to be loaded and linked to the system. Exemplary actions that may be followed by the API functions are shown in FIG. 2.

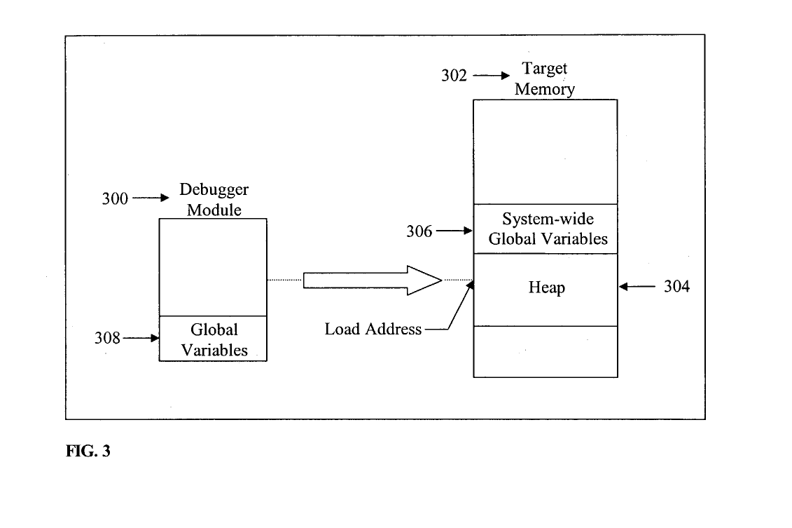

Exemplary action 200 of the loading and linking mechanism as illustrated in FIG. 2 is illustrated in further detail in FIG. 3. FIG. 3 shows exemplary module structure and exemplary memory organization of the target memory in the system model. Exemplary action 200 of the loading linking mechanism allocates a memory space from the memory of the target system 302, and loads the pre-compiled debugger module 300 into this memory location. The place to which debugger module is loaded may be a free memory block in the heap section 304 of the memory. If there is no such block available in which to fit the debugger module, the system looks for any other modules that have been unlinked from the OS, but that are still in the memory. This can be done provided that the option which keeps the unlinked modules in the memory until their de-allocated space is re-allocated for another purpose is enabled in the system. If the required memory space is satisfied by the previously allocated memory for those unlinked modules, the system uses the memory space of such modules. If enough memory cannot be obtained in this way, the system asks the user to choose among the already loaded and active debugger module(s) (i.e., the modules that are linked to the OS) the one(s) to be replaced with the new module to be loaded.

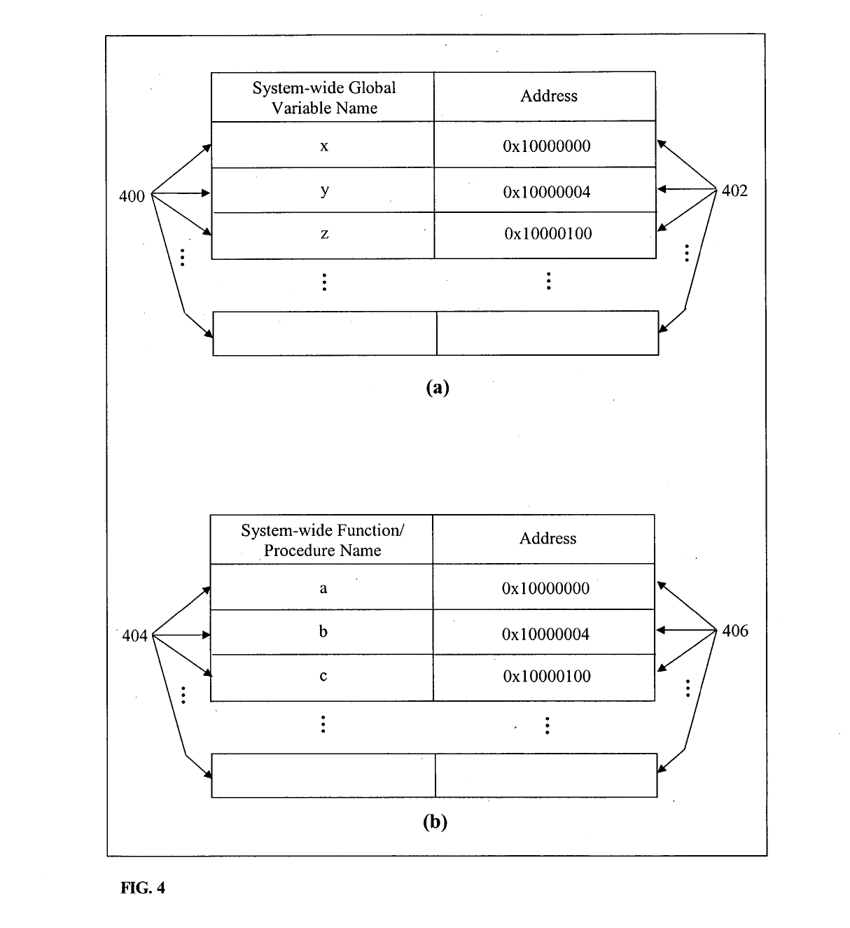

Exemplary action 202 of FIG. 2 of the loading and linking mechanism is performed by using a global variable table (also known as a table) shown in FIG. 4a. A global variable table entry holds the name 400 and the address 402 of a system-wide global variable that may be referenced from within OS. A newly loaded module into the system which wants to access a system-wide global variable first searches the address of that system-wide global variable by using the symbol name of that system-wide global variable in the global variable table. After finding the address of the searched system-wide global variable, the newly loaded module initializes a pointer to the found address. Then, whenever the system-wide global variable is to be accessed, the initialized pointer is used to access that variable without requiring any more searches in the global variable table.

In addition to system-wide global variables, each loaded module may have its own global variables 308 local to that module as shown in FIG. 3. The names and the addresses of those global variables local to the debugger module are entered into the global variables table when that debugger module is linked to the OS. In this way, global variables local to a newly added debugger module to the OS are made accessible throughout the OS, and thus those global variables become a part of system-wide global variables as well.

Finally, any function or procedure within the debugger module can be referenced within the OS by using another table, module table shown in FIG. 4b. In the module table, there is a respective entry for every system-wide function or procedure within the OS. Each entry includes the symbol name of a function or procedure 404 and the address 406 in the target system memory where that function or procedure is loaded. This address is updated at action 204 of FIG. 2 of the loading and linking mechanism after the beginning address of the memory space into which a debugger module will be loaded becomes apparent. A newly loaded debugger module into the system which wants to access a system-wide function or procedure first searches the address of that system-wide function or procedure by using the symbol name of that system-wide function or procedure in the module table. After finding the address of the searched system-wide function or procedure, the newly loaded debugger module initializes a function pointer to the found address. Then, whenever the system-wide function or procedure is to be accessed, the initialized function pointer is used to access that function or procedure without requiring any more searches in the module table. Finally, when a new debugger module is to be integrated into the OS, new entries are dynamically created in the module table for every function or procedure within that debugger module.

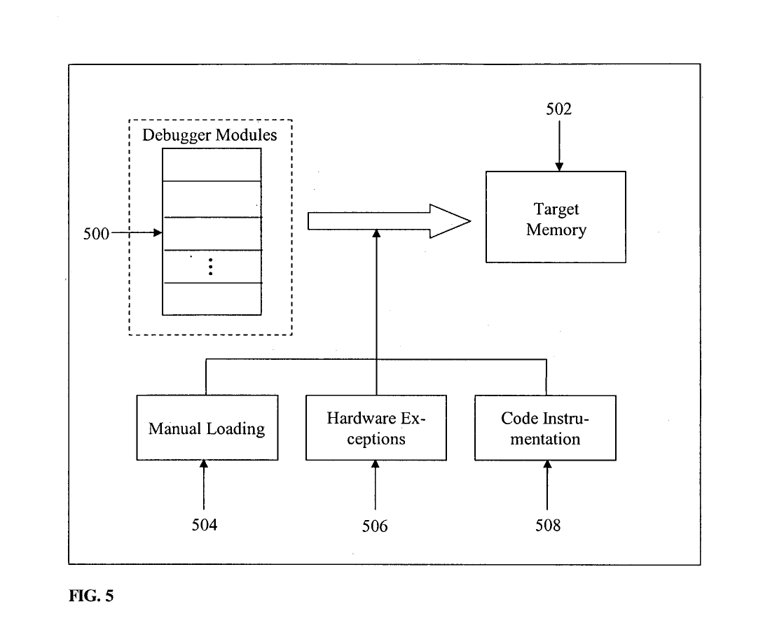

Dynamic module loading can be done in different ways (FIG. 5). The first option is manual loading 504. In manual loading, the user can stop the debugging session and choose to add new modules 500 to the system at any time. The second option is module loading triggered by hardware exceptions 506. Hardware exceptions are instruction related interrupts caused by software trying to execute an instruction in a way not supported by the underlying hardware. Hardware exceptions are caught by the support of the underlying hardware.

A typical example of a hardware exception is an alignment exception, which is usually caused by executing a load/store instruction with misaligned operands. When a hardware exception occurs, the system selects the base debugger modules that will be helpful to understand the cause of the hardware exception and, if this option is enabled, asks the user's permission to load them into the system dynamically. At this moment, the user can confirm the load request, decline the request totally, or select among the base debugger modules the ones to be loaded into the target system. The user can also select any other expansion debugger modules to be loaded into the system at the time of the hardware exception to provide extra debugging features above the base modules. The base debugger modules for a specific kind of hardware exception are set by the user at compile time, but can be changed any time by the user. The user can also disable the permission request from the system at any time, so that at the time of a hardware exception, base modules are loaded without the user's intervention.

The last module loading option is module loading triggered by custom instrumentation code 508 added by the user either into the application program or to the OS or both. This instrumentation code can be any monitoring code that checks for the predefined conditions to be satisfied for triggering the loading of debugger modules. Assertions are good examples for the instrumentation code that can be added into the code being debugged. Assertions are linguistic constructions which allow either runtime checking or compile time checking of constraints defined in the programs. Other than the type of source that triggers module loading, module loading by code instrumentation works in the same way as in the hardware exception case with the same options given to the user before or after a module loading is triggered.

During error-free operation at runtime, the debugger modules are not typically loaded into the system provided that the user does not request any manual module loading. This prevents consumption of extra system resources by the debugging software. When the debugger modules are not loaded into the system, they are kept generally in a storage unit external to the target system. This storage unit may be the hard drive 102 of the host computer 104 shown in FIG. 1 or any other local or remote storage device that has a wired or wireless link to the system in FIG. 1. As soon as an error condition occurs (e.g., hardware rises an exception or a software assertion fires), the debugger modules are loaded from the external storage unit into the memory of the target system and are dynamically linked to the OS.

If a module is no longer needed, it can be removed from the system easily. To do this, an exemplary embodiment of the inventions first makes sure that the module is not currently running in the system. If the module is running, the system waits until the module finishes its execution. After that, the module is marked as discardable, which distinguishes it from the rest of the active modules (i.e., those that are linked to the OS) and ensures that it cannot be called from within the OS. Finally, the memory space allocated for the module is released. However, as an option, the module may be kept in the memory until the released memory space that was allocated for the module is actually used for some other purpose. In this way, if the module is ever needed again, the module can be made active very quickly as it will already be in the target system memory.

An exemplary embodiment of the present inventions provides the detection of a divide-by-zero error by code instrumentation and triggering of a load operation for a debugger module. Note that some processors do not have hardware support for the detection of a divide-by-zero error, especially for the integer divide operation. Therefore, in addition to presenting an application of the inventions, this exemplary embodiment introduces a solution for this problem, too.

The instrumentation code for the detection of a divide-by-zero error is implemented in the following exemplary way. Class types of int_check, float-check and double_check are defined for all data types in the OS, which include an overloading of the division operator (“/”) using the C++ language. The overloaded division operator checks the second operand of the division operation. If the second operator is found to be zero, the overloaded division operator calls the aforementioned API functions for loading and linking the custom-made debugger module. Thus, the ordinary division operator gains a functionality of checking for the divide-by-zero condition. Then, the int_check, float_check and double_check class types are mapped into the corresponding generic data types INT, FLOAT and DOUBLE, respectively. Thus, when the application programmer uses a division operator (“/”) with operands of these generic data types, he or she actually uses the modified division operator which detects the divide-by-zero error condition.

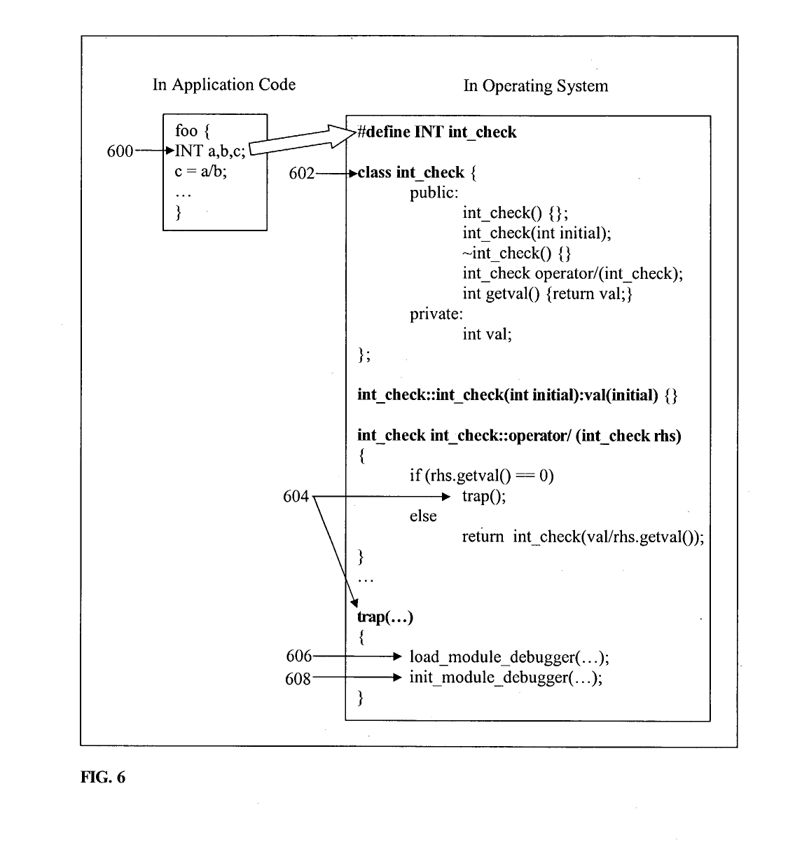

The integer divide-by-zero error detection mechanism is illustrated in the diagram in FIG. 6. The generic data type INT 600 is converted into int_check class type 602 (which is defined in the OS code) during the compilation of the source code. When a divide-by-zero error condition occurs (which is checked by the int_check class type implicitly), a trap( ) 604 function is called, which in turn calls the load_module_debugger( ) 606 and init_module_debugger( ) 608 API functions that are written for taking care of the dynamic module loading and linking actions shown in FIG. 2.

In the described embodiment, an application and an implementation of Debugger OS run on a target embedded controller board and the user interface runs on a host computer with input/output devices such as a keyboard and a monitor. The host computer is connected to the target board via a high bandwidth JTAG interface (e.g., 100 KB/sec) by which debugging information can be retrieved from the target board. For this preferred embodiment, the CrossView Pro Tool from Tasking Inc. is chosen to provide the user interface and the host side drivers for the JTAG connection. The user interface can be any commercially available or custom-made software that can interpret the received signals from the communication interface. Note that JTAG interface is not used in conjunction with the available debugger logic on the target processor as mentioned in the prior art section, but just for data transfer between the host and the target. Again, as mentioned before, the communication interface can be replaced with any other suitable interface, even with a wireless connection.

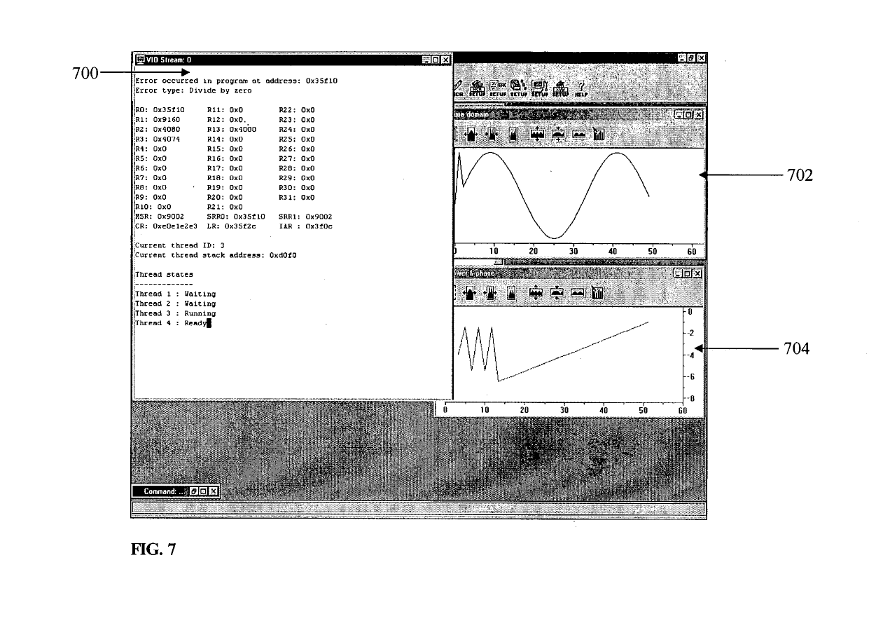

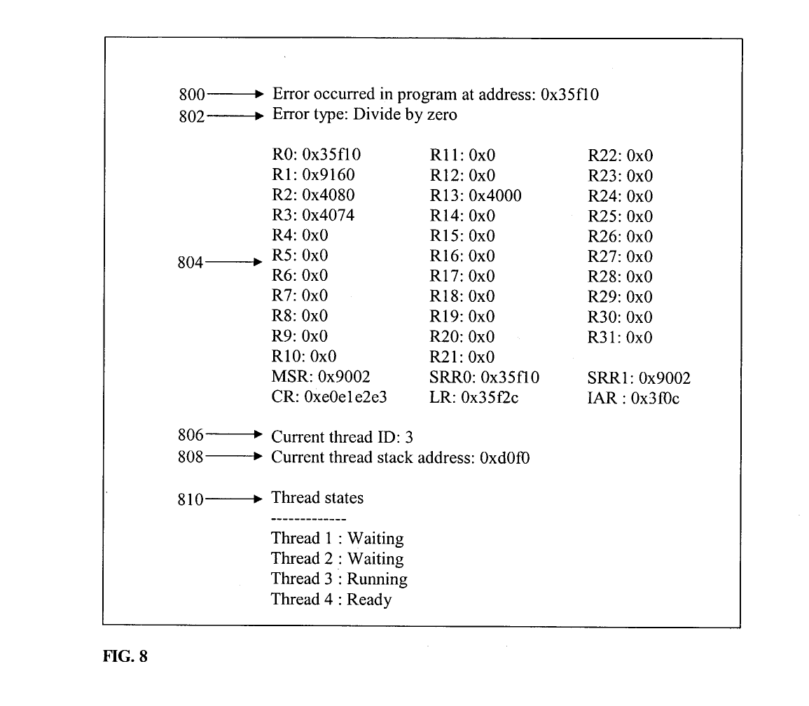

The exemplary embodiment is applied with respect to three threads. However, any other application with as many threads as allowed by the installed memory on the target platform is supported by the inventions. Two threads read two different sets of floating-point voltage samples from a file record and display the waveforms on the screen. The third thread rounds the voltage values by assigning them to integer variables and computes the ratio of them by dividing one of the rounded samples by the other. When one of the divisor voltage samples is between −1 and +1, it is rounded to zero, and thus a divide-by-zero error condition occurs. A snapshot of the user interface running on the host is show in FIG. 7. Three windows are shown in the snapshot: the output window from the custom-made debugger module 700, the plot of dividend voltage samples versus time 702, and the plot of divisor voltage samples versus time 704. The magnified view of the output from the custom-made debugger module is shown in FIG. 8. The debugger module reports the error location 800, the error type 802, processor register values 804, current thread ID 806, the beginning address of the stack of current thread 808 and the states of threads in the system 810. Note that the fourth thread, of which status is shown as “ready” in the sample output, is the idle thread created by the operating system in the system initialization phase.

As seen in FIG. 8, valuable information about the OS internals can easily be obtained. The debugger module is loaded into the system only when needed, that is, when a divide-by-zero error occurs. In this way, memory overhead by the debugger module is reduced during error-free operation.

As another embodiment of the inventions, dynamic addition of OS-aware breakpoint support to the system is explained next. With OS-aware breakpoint support, it is possible to differentiate between threads, so that a breakpoint set for a single thread effects the execution only of that thread. Even if another thread runs the same code at the same physical memory location, the execution of that thread is not affected (not stopped at the breakpoint).

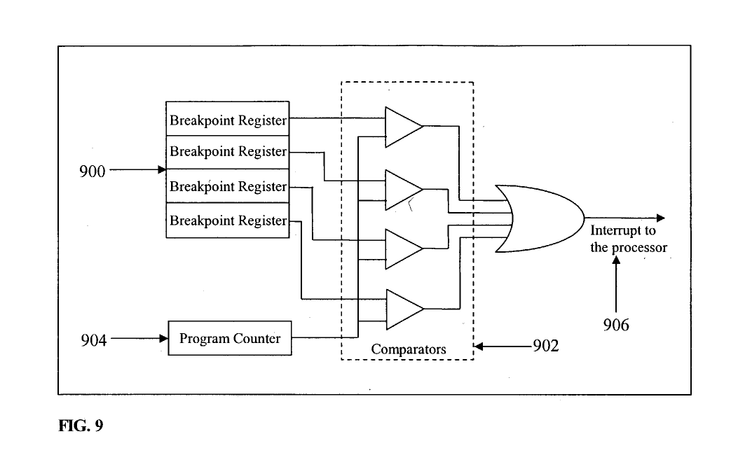

Conventionally, the breakpoint feature within a debugger tool is implemented at a low level. This traditional implementation relies on either hardware or software (assembly code). In case of hardware, the target processor, on which the software that is being debugged runs, contains custom logic for breakpoints. As seen in FIG. 9, this logic may include a set of registers that are called breakpoint registers 900 and a set of comparators 902. The addresses of instructions where breakpoints are set are written into the breakpoint registers. Then, the value of program counter 904 is continuously compared with the values in the breakpoint registers. If a match is found, an internal interrupt 906 is generated which stops the execution and notifies the debugger tool. Since hardware merely checks instruction addresses, it is not capable of differentiating between threads. Moreover, with hardware, the number of breakpoints that can be set simultaneously is limited by the number of available breakpoint registers.

In the case of software, a low level routine replaces the instruction at the breakpoint address with an invalid instruction or a branch instruction to a predefined address. When the breakpoint is reached, an invalid instruction exception is given or the control reaches the predefined address, and the debugger tool is notified. However, this software approach still performs at the processor assembly instruction level, which prevents separation between different thread executions.

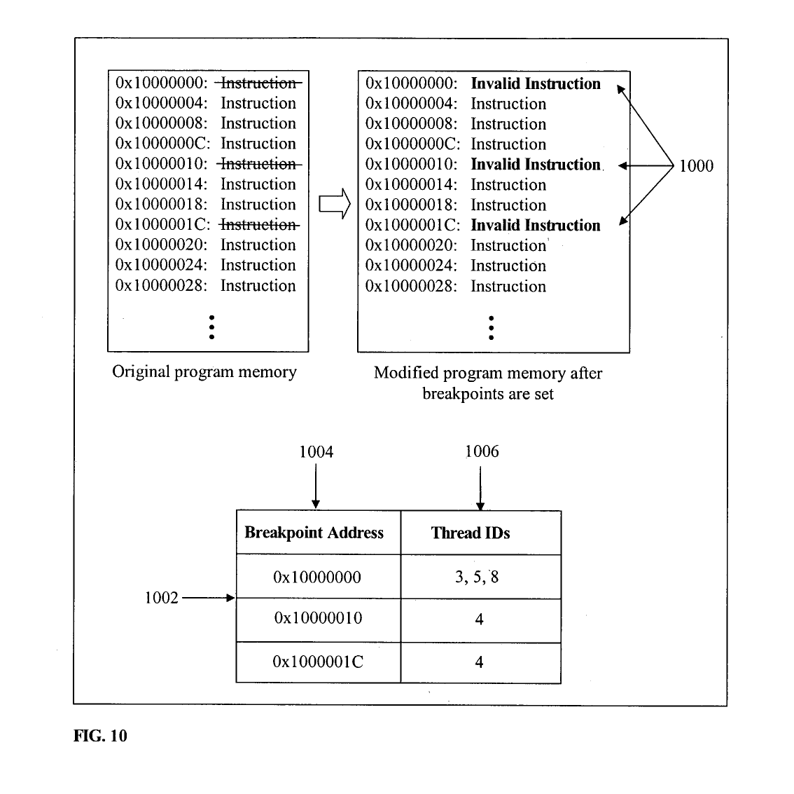

In the preferred embodiment of the present invention for OS-aware breakpoint support, the exemplary debugging platform of FIG. 1 is used. Breakpoint support is added to the system by an exemplary debugger module that is dynamically linked to the OS. As shown in FIG. 10, the debugger module includes a small routine that replaces the instruction at the breakpoint address with an invalid instruction 1000 as explained in the conventional software approach. In addition to this routine, the debugger module keeps a table, which is called a breakpoint table 1002, that associates with a breakpoint address 1004 the thread ID 1006 for which the breakpoint is set. When the breakpoint is reached on a target processor, the target processor gives an exception and the processor jumps to the exception routine.

As opposed to the conventional software approach, however, the control is not returned back to the user interface on the host immediately. The breakpoint address 1004 is found in the breakpoint table 1002 and the corresponding thread ID or IDs are compared with the current thread ID that was running when the breakpoint is reached. If a match is found, then the user interface takes over the control. On the other hand, if the IDs do not match, then the control is immediately returned back to the interrupted thread. In this way, only the threads that are marked with breakpoints are interrupted while the other threads are left running. This exemplary embodiment of the inventions shows that the integration of the debugger modules within the OS provides the necessary information for OS-aware debugging, which cannot be achieved with conventional low-level debugging technologies.

What is claimed is:

1. In a computer system including a host system functionally connected to a target system, a method for configuring a debugger system that saves resources of the target system, and yet allows for debugging operations to be conducted on the target system rather than from the host system, the method comprising:
storing a global variable table at the target system with the global variable table including at least an entry and with each entry respectively including a name of a system-wide global variable and an address for the system-wide global variable;
storing a module table at the target system with the module table including at least a module table entry (MT entry) with each MT entry respectively identifying a system-wide function and a module table address (MT address) for the system-wide function;
creating a respective debugger module for each debugging feature included in the debugger system;
storing at least a debugger module of the debugger system in the host system;
in response to a trigger, loading a debugger module from the host system to the target system; and
linking the debugger module for the debugging operations on the target system
by causing the debugger module to exchange information with the global variable table, and
by causing the debugger module to exchange function information with the module table,
whereby the storing at the host system of the debugger modules not in use at the target system saves the resources of the target system, and
whereby the loading and linking of the debugger module to the target system in response to the trigger allows for the debugging operations to be conducted on the target system rather than from the host system and also saves the resources of the target system by minimizing the resources of the target system taken up by the debugger system.

2. The method of claim 1, wherein causing the debugger module to exchange the information with the global variable table comprises:
causing the debugger module to use the global variable table to find a particular address of a particular system-wide global variable;
causing the debugger module to set a pointer to the particular address for accessing the particular system-wide global variable by the debugger module; and
causing the debugger module to provide the global variable table with at least a local name and a local address of a global variable local to the debugger module so that the global variable local to the debugger module becomes accessible to other components of the target system.

3. The method of claim 1, wherein causing the debugger module to exchange the function information with the module table comprises:
causing the debugger module to use the module table to find a particular MT address of a particular system-wide function;
causing the debugger module to set a pointer to the particular MT address for accessing the particular system-wide function by the debugger module; and
causing the debugger module to provide the module table with at least a local function and a local MT address of a system-wide function local to the debugger module so that the system-wide function local to the debugger module becomes accessible to other components of the target system.

4. The method of claim 3, further comprising:
causing the global variable table and the module table to be accessible to components linked to the target system with the components including linked debugging modules.

5. The method of claim 1, wherein the trigger comprises a manual loading, a hardware exception, or an instrumentation code.

6. The method of claim 1, wherein a debugging feature of the debugger system comprises a real-time functionality or a non-real-time functionality.

7. The method of claim 6, wherein the real-time functionality comprises a dynamic variable query or dynamic program tracing.

8. The method of claim 6, wherein the non-real-time functionality comprises a breakpoint or a single stepping support.

9. The method of claim 1, further comprising:
after the debugging operations on the target system, removing the debugger module from the target system to the host system.

10. The method of claim 1, wherein the target system comprises an embedded system.

11. The method of claim 1, wherein the host system is functionally connected to the target system over a communication interface, and further comprising:
after the debugging operations on the target system, causing the debugger module to send results of the debugging operations over the communication interface to the host system.

12. A method for configuring a debugger system in a system, the method comprising:
storing a table at the system with the table including at least an entry and with each entry respectively including a name of a variable and an address for the variable;
storing a module table at the system with the module table including at least a module table entry (MT entry) with each MT entry respectively identifying a function and a module table address (MT address) for the function; and
linking a debugger module including at least a debugger feature of the debugger system to the system
by causing the debugger module to exchange information with the table, and
by causing the debugger module to exchange function information with the module table.

13. The method of claim 12, wherein causing the debugger module to exchange the information with the table comprises:
causing the debugger module to use the table to find a particular address of a particular variable,
causing the debugger module to set a pointer to the particular address for accessing the particular variable by the debugger module, and
causing the debugger module to provide the table with at least a local name and a local address of a variable local to the debugger module.

14. The method of claim 12, wherein causing the debugger module to exchange the function information with the module table comprises:
causing the debugger module to use the module table to find a particular MT address of a particular function;
causing the debugger module to set a pointer to the particular MT address for accessing the particular function by the debugger module; and
causing the debugger module to provide the module table with at least a local function and a local MT address of a function local to the debugger module, so that the function local to the debugger module becomes accessible to other components of the system.

15. The method of claim 12, wherein causing the debugger module to provide the table with at least the local name and the local address of the variable local to the debugger module allows the variable local to the debugger module to be accessible to the other components of the system; and
wherein causing the debugger module to provide the module table with at least the local function and the local MT address of the function local to the debugger allows the function local to the debugger module to be accessible to the other components of the system.

16. The method of claim 12, wherein the system comprises an embedded system.

17. The method of claim 12, further comprising:
causing the debugger module to include a breakpoint support routine and a breakpoint table including at least an entry of a breakpoint address and a corresponding thread identifier (ID);
detecting a breakpoint having the breakpoint address in a running thread of the system;
in response to the detection, interrupting operation of the running thread and causing the breakpoint support routine to be invoked;
in response to being invoked, causing the breakpoint support routine to use a thread ID of the running thread to check the breakpoint table; and
if the thread ID of the running thread matches the corresponding thread ID, then causing control of the operation of the running thread to pass away from the system.

18. The method of claim 17, further comprising:
if the thread ID of the running thread fails to match the corresponding thread ID, then returning control of the operation to the running thread.

19. In a computer system including a host system functionally connected to a target system with running threads and with at least one of the running threads including a breakpoint, a method for debugging based on breakpoints that a breakpoint set with respect to a running thread effects only the running thread and not other threads running on the target system, the method comprising:
causing a debugger module to include a breakpoint support routine and a breakpoint table including at least an entry of a breakpoint address and a corresponding thread identifier (ID); linking the debugger module including the breakpoint support routine and the breakpoint table to the target system;
in response to detection of a breakpoint having the breakpoint address in a running thread of the target system, interrupting operation of the running thread and causing the breakpoint support routine to be invoked;
in response to being invoked, causing the breakpoint support routine to use a thread ID of the running thread to check a breakpoint table; and
if the thread ID of the running thread matches the corresponding thread ID, then causing control of the operation of the running thread to pass to the host system.

20. The method of claim 19, further comprising:
if the thread ID of the running thread fails to match the corresponding thread ID, then returning control of the operation to the running thread.
